(19) United States
(12) Patent Application Publication
(10) Pub. No.: US 2006/0098456 A1
(43) Pub. Date: May 11, 2006

(54) Backlight device and liquid crystal display device including the same

(75) Inventors: Michiaki Sakamoto, Kawasaki-shi (JP); Masataka Baba, Kawasaki-shi (JP); Hiroshi Hada, Kawasaki-shi (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD, KAWASAKI-SHI (JP)

(21) Appl. No.: 11/272,080

(22) Filed: Nov. 14, 2005

(30) Foreign Application Priority Data
Nov. 11, 2004 (JP) 2004-327291

(51) Int. Cl. F21V 7/04

(52) U.S. Cl. 362/625; 362/606

(57) ABSTRACT

The backlight device used for a liquid crystal display device includes (a) an inverted-prism sheet, (b) a light-guide arranged adjacent to the inverted-prism sheet, (c) a light-reflection sheet arranged adjacent to the light-guide, and (d) a light-source emitting a light into the light-guide. The light-guide is formed on a first surface thereof facing the light-reflection sheet with at least one groove defining a light-reflection surface at which a light provided from the light-source is reflected obliquely towards the inverted-prism sheet.

### BACKGROUND OF THE INVENTION

1. Field of the Invention

The invention relates to a backlight device arranged at the rear of a display unit in a display device, and further to a liquid crystal display device including the backlight device.

2. Description of the Related Art

A liquid crystal display device is grouped into a light-transmission type liquid crystal display device in which a light emitted from a backlight device passes through a liquid crystal layer, a light-reflection type liquid crystal display device in which an external light entering a liquid crystal layer is reflected, and a combination type liquid crystal display device which has structural features of both a light-transmission type liquid crystal display device and a light-reflection type liquid crystal display device, namely, which has a first area in which a light emitted from a backlight device passes through a liquid crystal layer, and a second area in which an external light entering a liquid crystal layer is reflected.

A combination type liquid crystal display device is predominantly used in a mobile device such as a mobile phone or a personal digital assistant (PDA) because of high image quality presented by a light-transmission type liquid crystal display device, and high visibility of an external light.

A combination type liquid crystal display device is further grouped into an internal light-reflection type device in which a light is reflected in a liquid crystal cell, and an external light-reflection type device in which a light is reflected outside of a liquid crystal cell.

FIG. 1 is a cross-sectional view of an external light-reflection type liquid crystal display device suggested in Japanese Patent Application Publication No. 2003-098325.

As illustrated in FIG. 1, the external light-reflection type liquid crystal display device 100 is comprised of a liquid crystal layer 101 including liquid crystal therein, an upper polarizer plate 102 disposed on the liquid crystal layer 101, a lower polarizer plate 103 disposed beneath the liquid crystal layer 101, a light-reflection polarizer plate 105 adhered to a lower surface of the lower polarizer plate 103 through light-diffusive adhesive 104, an inverted-prism sheet 106 disposed beneath the light-reflection polarizer plate 105, a light-guide 107 disposed beneath the inverted-prism sheet 106, a diffusion dot pattern 108 disposed beneath the light-guide 107, a light-reflection sheet 109 disposed beneath the diffusion dot pattern 108, and a light-emitting diode (LES) 110 as a light-source, disposed adjacent to the light-guide 107.

The light-reflection polarizer plate 105 is comprised of a polarizer plate, and a sheet adhered to a lower surface of the polarizer plate through light-diffusive adhesive for enhancing brightness.

The inverted-prism sheet 106 includes a plurality of prisms on a lower surface thereof. Each of the prisms projects downwardly, and has an inverse triangular cross-section.

The inverted-prism sheet 106, the light-guide 107, the diffusion dot pattern 108, the light-reflection sheet 109, and the light-emitting diode 110 cooperate with one another to define a backlight device 111.

The inverted-prism sheet 106 disposed below the liquid crystal layer 101 enhances a light-reflection rate in the liquid crystal display device 100. As a result, when images are displayed without turning on the light-emitting diode 110 acting as a light-source, namely, when the liquid crystal display device 100 is used in a light-reflection mode, a viewer can see images in a display screen with enhanced brightness.

When images are displayed in a display screen by turning on the light-emitting diode 110 acting as a light-source in the liquid crystal display device 100 illustrated in FIG. 1, namely, when the liquid crystal display device 100 is used in a light-transmission mode, a light emitted from the light-emitting diode 110 and entering the light-guide 107 is upwardly reflected in the light-guide 107, and upwardly leaves the light-guide 107.

Japanese Patent Application Publication No. 2002-245825 has suggested a liquid crystal display device including a backlight device 300 illustrated in FIG. 2.

As illustrated in FIG. 2, the backlight device 300 is comprised of a light-source unit 310 including a light-source therein, and a light-guide 320 through which a light emitted from the light-source unit 310 and entering the light-guide 320 is frontally directed.

The light-guide 320 has a flat upper surface 330 and a lower surface 321 in which a plurality of prisms are formed. The lower surface 321 defines light-reflection surfaces 322 and light-transmission surfaces 323 alternately. A light 350 emitted from the light-source unit 310 is frontally reflected at the light-reflection surface 322. The light-transmission surface 323 allows a frontally coming light to pass therethrough towards a light-reflection sheet (not illustrated) arranged below the light-guide 320.

The light-reflection surfaces 322 incline at an angle in the range of 40 to 50 degrees relative to the upper surface 330, and the light-transmission surfaces 323 incline at few angles relative to the upper surface 330.

FIG. 3 is a cross-sectional view of an external light-reflection type liquid crystal display device suggested in Japanese Patent Application Publication No. 2004-054034.

As illustrated in FIG. 3, the suggested liquid crystal display device 200 is comprised of a liquid crystal layer 201 including liquid crystal therein, an upper polarizer plate 202 disposed on the liquid crystal layer 201, a lower polarizer plate 203 disposed beneath the liquid crystal layer 201, a light-reflection polarizer plate 205 adhered to the lower polarizer plate 203 with a light-diffusing layer 204 being sandwiched therebetween, an inverted-prism sheet 206 disposed beneath the light-reflection polarizer plate 205, a light-guide 207 disposed beneath the inverted-prism sheet 206, a light-reflection plate 209 disposed beneath the light-guide 207, and a light-source 210 disposed adjacent to the light-guide 207.

As mentioned above, the liquid crystal display device 100 illustrated in FIG. 1 makes it possible to enhance brightness.

However, the liquid crystal display device 100 is accompanied with a problem that since lights leaving the light-guide 107 frontally (that is, upwardly in FIG. 1) in a light-transmission mode, most of the lights are downwardly reflected at a lower surface of the inverted-prism sheet 106, as shown with an arrow 112, resulting in that it is quite difficult to have sufficient brightness in a light-transmission mode.

The liquid crystal display device including the backlight device illustrated in FIG. 2 is accompanied with a problem that a light La, having brightness of about 1500 Cd when the light-source 310 emits a light having brightness of 2100 Cd, reflected at a lower surface of the light-guide 320 is effectively used in a light-transmission mode, as illustrated in FIG. 2, but a light Lb, having brightness of about 600 Cd when the light-source 310 emits a light having brightness of 2100 Cd, reflected at the light-reflection sheet 340 is not effectively used.

Japanese Patent Application Publication No. 2004-054034 explains that an apex angle α of the inverted-prism sheet 206 in the liquid crystal display device 200 illustrated in FIG. 3 is preferably in the range of 63 to 68 degrees.

However, Japanese Patent Application Publication No. 2004-054034 is silent with respect to a shape of the light-guide 207.

Furthermore, as illustrated in FIG. 4, if a diffusion-dot type light-guide is used as the light-guide 207 in the liquid crystal display device 200 illustrated in FIG. 3, an external light having passed through the inverted-prism sheet would be confined in the diffusion-dot type light-guide 207, resulting in that an external light cannot be effectively used in a light-reflection mode of the liquid crystal display device 200. Thus, Japanese Patent Application Publication No. 2004-054034 fails to suggest a detailed shape of the light-guide 207 for enhancing an efficiency with which an external light is used in a light-reflection mode of the liquid crystal display device 200.

The inventors thoroughly studied the light-guide 207 in the liquid crystal display device 200, and found that a light entering the light-guide 207 from the light-source 210 disposed adjacent to the light-guide 207 was not emitted towards the inverted-prism sheet 206 from the light-guide 207. Accordingly, it is necessary to determine an appropriate shape of the light-guide 207.

Furthermore, since the light-source 210 is attached directly to a side of the light-guide 207, the light-source 210 provides poor uniformity of light flux. This results in a problem that, when viewed vertically, such light fluxes 220 as illustrated in FIG. 5 can be seen. Thus, it is necessary to determine how a light-source is mounted onto a light-guide.

### SUMMARY OF THE INVENTION

In view of the above-mentioned problems in the conventional backlight devices, it is an object of the present invention to provide a backlight device which is capable of providing sufficient brightness in a light-transmission mode in which a light-source is turned on.

It is also an object of the present invention to provide a backlight device which is capable of providing enhanced uniformity in light flux.

It is further an object of the present invention to provide a liquid crystal display device including the above-mentioned backlight device.

Hereinbelow is described a backlight device and a liquid crystal display device both in accordance with the present invention through the use of reference numerals used in later described embodiments. The reference numerals are indicated only for the purpose of clearly showing correspondence between claims and the embodiments. It should be noted that the reference numerals are not allowed to interpret claims of the present application.

In one aspect of the present invention, there is provided a backlight device (75) used for a display device, including (a) an inverted-prism sheet (6), (b) a light-guide (7) arranged adjacent to the inverted-prism sheet (6), (c) a light-reflection sheet (8) arranged adjacent to the light-guide (7), and (d) a light-source (74) emitting a light into the light-guide (7). The light-guide (7) is formed on a first surface thereof facing the light-reflection sheet (8) with at least one groove (71) defining a light-reflection surface (712) at which a light provided from the light-source (74) is reflected obliquely towards the inverted-prism sheet (6).

For instance, the groove (71) has a triangular cross-section.

It is preferable that the first surface (72) is flat except the groove (71).

It is preferable that the light-reflection surface (712) inclines at such an angle relative to a direction in which a viewer frontally views the liquid crystal display device (10, 20) that a light leaves the light-guide (7) at an angle in the range of about 50 to about 80 degrees both inclusive relative to the direction.

It is preferable that the groove (71) is defined by two surfaces, one (711) of which extends perpendicularly to the first surface of the light-guide (7).

It is preferable that the inverted-prism sheet (6) has a prism (61) having an apex angle in the range of 60 to 70 degrees both inclusive.

There is further provided a backlight device (75) used for a display device, including (a) an inverted-prism sheet (6), (b) a light-guide (7) arranged adjacent to the inverted-prism sheet (6), (c) a light-reflection sheet (8) arranged adjacent to the light-guide (7), (d) a light-source (74) emitting a light into the light-guide (7), and (e) a light-guide pipe (73) arranged adjacent to the light-guide (7) for introducing a light provided from the light-source (74), into the light-guide (7) therethrough. The light-guide (7) is formed on a first surface thereof facing the light-reflection sheet (8) with at least one groove (71) defining a light-reflection surface (712) at which a light provided from the light-source (74) is reflected obliquely towards the inverted-prism sheet (6).

The light-guide pipe (73) receives a light from the light-source (74), reflects the light therein, and introduces the light into the light-guide (7).

It is preferable that an angle at which a light is introduced into the light-guide pipe (73) from the light-source (74), and an angle of a surface (731) of the light-guide pipe (73) at which a light (L1) provided from the light-source (74) is reflected in the light-guide pipe (73) towards the light-guide (7) are determined such that lights (L2) introduced into the light-guide (7) from the light-guide pipe (73) are in parallel with one another.

In another aspect of the present invention, there is provided a liquid crystal display device (10, 20), including (a) the above-mentioned backlight device (75), and (b) a liquid crystal panel (11) arranged closer to a viewer than the backlight device (75).

The advantages obtained by the aforementioned present invention will be described hereinbelow.

In accordance with the present invention, the light-guide is formed at a surface thereof facing a light-reflection sheet with a groove or grooves. The groove or each of the grooves defines a light-reflection surface at which a light provided from a light-source is reflected obliquely towards an inverted-prism sheet. Hence, in a light-transmission mode in which a light-source is turned on, it is possible to reflect a light entering the light-guide, at the light-reflection surface of the groove(s) towards the inverted-prism sheet. Namely, an incident light is preferably introduced to the inverted-prism sheet from the light-guide.

In addition, since a light is reflected at the light-reflection surface obliquely towards the inverted-prism sheet, it is possible to prevent the light from reflecting at a lower surface of the inverted-prism sheet towards the light-guide, ensuring enhancement in an efficiency with which a light is used in a light-transmission mode, in comparison with the conventional backlight device.

The backlight device in accordance with the present invention may be designed to additionally include a light-guide pipe disposed adjacent to the light-guide, in which case, a light emitted from a light-source enters the light-guide pipe and is reflected in the light-guide pipe towards the light-guide, and then, enters the light-guide. Furthermore, an angle at which a light is introduced into the light-guide pipe from a light-source, and an angle of a surface of the light-guide pipe at which a light provided from a light-source is reflected in the light-guide pipe towards the light-guide are determined such that lights introduced into the light-guide from the light-guide pipe are in parallel with one another. Accordingly, it is possible to enhance uniformity in light flux in a light-transmission mode, and display high-quality images in a light-transmission mode without non-uniformity in brightness.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a cross-sectional view of a conventional external light-reflection type liquid crystal display device.

FIG. 2 is a cross-sectional view of a backlight device included in another conventional liquid crystal display device.

FIG. 3 is a cross-sectional view of still another conventional external light-reflection type liquid crystal display device.

FIG. 4 is another cross-sectional view of the external light-reflection type liquid crystal display device illustrated in FIG. 3.

FIG. 5 is a top view of the external light-reflection type liquid crystal display device illustrated in FIG. 3.

FIG. 6A is a cross-sectional view of the liquid crystal display device in accordance with the first embodiment of the present invention.

FIG. 6B is a top view of the light-guide in the liquid crystal display device in accordance with the first embodiment of the present invention.

FIG. 7A is a cross-sectional view of the liquid crystal display device in accordance with the second embodiment of the present invention.

FIG. 7B is a top view of the light-guide in the liquid crystal display device in accordance with the second embodiment of the present invention.

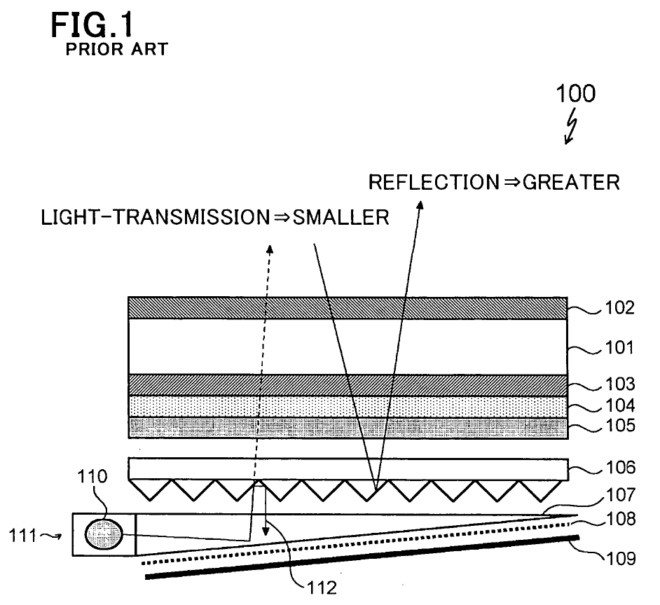

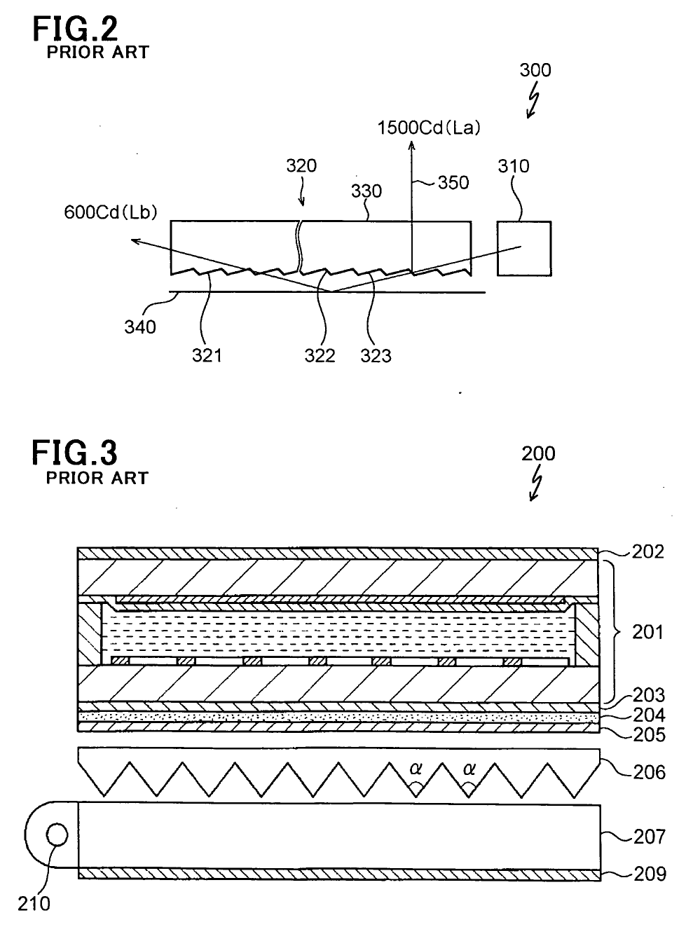

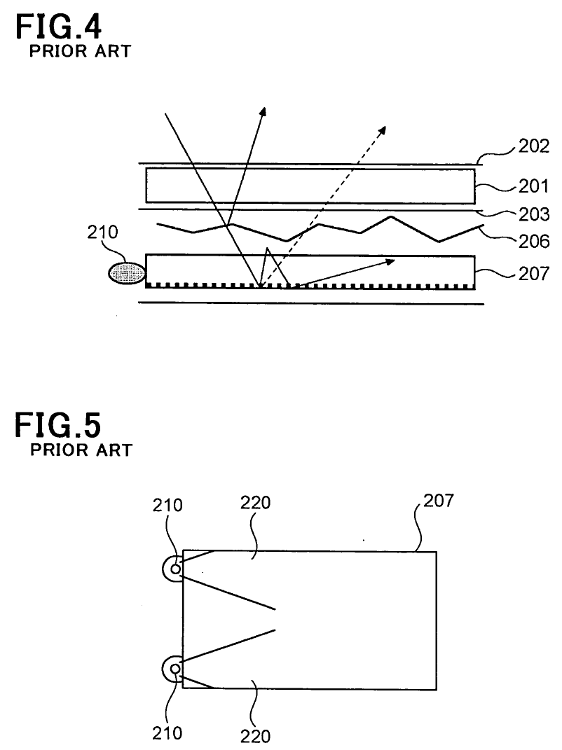

### DESCRIPTION OF THE PREFERRED EMBODIMENTS

Preferred embodiments in accordance with the present invention will be explained hereinbelow with reference to drawings.

### First Embodiment

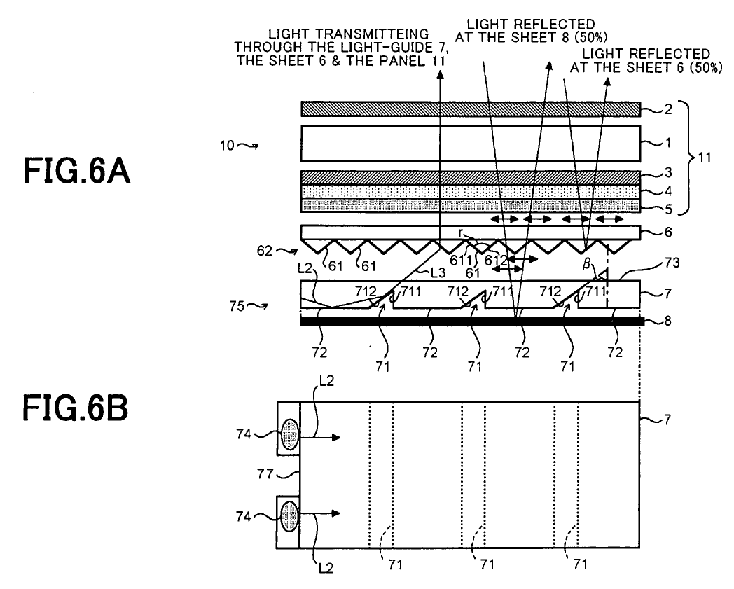

FIG. 6A is a cross-sectional view of the liquid crystal display device 10 in accordance with the first embodiment, and FIG. 6B is a top view of the light-guide 7 included in the liquid crystal display device 10.

As illustrated in FIG. 6A, the liquid crystal display device 10 is an external light-reflection type liquid crystal display device, and is comprised of a liquid crystal layer 1 including liquid crystal therein, an upper polarizer plate 2 disposed on the liquid crystal layer 1, a lower polarizer plate 3 disposed beneath the liquid crystal layer 1, a light-reflection polarizer plate 5 adhered to a lower surface of the lower polarizer plate 3 through light-diffusive adhesive 4, an inverted-prism sheet 6 disposed beneath the light-reflection polarizer plate 5, an inverted-prism type light-guide 7 disposed beneath the inverted-prism sheet 6, a light-reflection sheet 8 disposed beneath the light-guide 7 for upwardly reflecting a light downwardly leaving the light-guide 7, and light-sources 74 disposed adjacent to the light-guide 7.

The liquid crystal layer 1, the upper polarizer plate 2, the lower polarizer plate 3, the light-diffusive adhesive 4 and the light-reflection plate 5 are formed integrally with one another to thereby define a liquid crystal panel 11.

The light-reflection plate 5 is comprised of a polarizer (not illustrated), and a sheet (not illustrated) adhered to a lower surface of the polarizer with light-diffusive adhesive (not illustrated) being sandwiched therebetween, for enhancing brightness.

It is preferable that the lower polarizer plate 3, the light-diffusive adhesive 4, the light-reflection plate 5, and the inverted-prism sheet 6 are formed integrally with one another. By forming them integrally with one another, it is possible to avoid a gap between the inverted-prism sheet 6 and the light-reflection plate 5, ensuring that it is possible to prevent a light from entering the gap and being confined in the gap. From the standpoint of mass-productivity, the lower polarizer plate 3, the light-diffusive adhesive 4, the light-reflection plate 5, and the inverted-prism sheet 6 may be designed not to be formed integrally with one another.

The light-diffusive adhesive 4 is used for adhering the light-reflection plate 5 to the lower polarizer plate 3 because it is necessary for a reflected light to have broader reflection property than reflection property of a regularly reflected light.

The light-diffusive adhesive 4 is selected in place of a light-diffusive sheet usually selected in a liquid crystal display device for the purpose of preventing reduction of polarization. A light-diffusive sheet may be used in place of the light-diffusive adhesive 4, if the light-diffusive sheet had an extremely low haze.

The inverted-prism sheet 6 is formed at a lower surface thereof facing the light-guide 7, with a prism group 62 comprised of a plurality of prisms 61 downwardly projecting. Each of the prisms 61 has a cross-section of an inverse triangle, and extends in a direction perpendicular to a plane of FIG. 6A. In FIG. 6A, a reference numeral is written only to a part of the prisms 61 for simplification.

The inverted-prism sheet 6 frontally reflects frontally coming lights in a light-reflection mode in which the light-sources 74 are turned off. In contrast, the inverted-prism sheet 6, in a light-transmission mode in which the light-sources 74 are turned on, not only frontally reflects frontally coming lights, but also turns a direction in which a light obliquely leaves the light-guide 7, into a direction in which a light almost frontally goes.

The light-guide 7 is composed of a material allowing a light to pass therethrough, such as acrylic resin, and is in the form of a rectangular parallelepiped plate.

The light-guide 7 is formed at a lower surface thereof with a plurality of grooves 71 equally spaced away from one another. Thus, the light-guide 7 is in the form of an inverted-prism.

Each of the grooves 71 has a triangular cross-section, and extends perpendicularly to a plane of FIG. 6A.

A lower surface of the light-guide 7, that is, a face of the light-guide 7 facing the light-reflection sheet 9 is formed as a flat surface 72 except the grooves 71.

An upper surface 73 of the light-guide 7 is also a flat surface. The flat upper surface 73 and the flat surface 72 in the lower surface are both perpendicular to a frontal direction of the liquid crystal display device 10. That is, the flat upper surface 73 and the flat surface 72 in the lower surface are in parallel with each other.

Each of the grooves 71 is defined by a surface 712 closer to the light-sources 74 and a surface 711 remoter from the light-sources 74. The surface 712 is comprised of a light-reflection surface or an inclining surface which inclines at a certain angle relative to a frontal direction (namely, an upward direction in FIG. 6A) of the liquid crystal display device 10. The surface 711 is perpendicular to the flat surface 72, for instance.

In a light-transmission mode in which the light-sources 74 are turned on, a light entering the light-guide 7 from the light-sources 74 is reflected at the inclining surface 712 obliquely towards the inverted-prism sheet 6, and leaves the light-guide 7 at the upper surface 73 upwardly and obliquely towards the inverted-prism sheet 6. A light frontally entering the light-guide 7 leaves the light-guide 7 at the flat surface 72 towards the light-reflection sheet 8, and is reflected at the light-reflection sheet 8. Then, the light enters the light-guide 7 again through the flat surface 72, and frontally leaves the light-guide 7 at the upper surface 73. The lights frontally leaving the light-guide 7 are used for displaying images in a display screen.

Each of the light-sources 74 is comprised of a light-emitting diode (LED). The light-sources 74 are disposed adjacent to the light-guide 7 at a side 77 of the light-guide 7 extending in parallel with the grooves 71.

The inverted-prism sheet 6, the light-guide 7, the light-reflection sheet 8, and the light-sources 74 define a backlight device 75 in the liquid crystal display device 10 in accordance with the first embodiment.

In the backlight device 75, lights L2 are emitted from the light-sources 74 into the light-guide 7 in parallel.

The lights L2 having entered the light-guide 7 pass through the light-guide 7, and arrive at each of the grooves 71. The lights L2 are reflected at each of the inclining surfaces 712 of the grooves 71 upwardly and obliquely (namely, obliquely towards the inverted-prism sheet 6), and upwardly and obliquely leaves the light-guide 7 through the upper surface 73.

The lights having upwardly and obliquely left the light-guide 7 through the upper surface 73 are caused by the prisms 61 of the inverted-prism sheet 6 to go frontally of the liquid crystal display device 10.

Thus, lights emitted from the light-sources 74 contribute to displaying images in a display screen of the liquid crystal display device 10.

The inclining surface 712 inclines at such an angle relative to a direction in which a viewer frontally views the liquid crystal display device 10 that a light L3 leaves the light-guide 7 through the upper surface 73 thereof at an angle in the range of about 50 to about 80 degrees both inclusive relative to the above-mentioned direction, for instance. The light L3 has an intensity peak when it leaves the light-guide 7 through the upper surface 73.

The liquid crystal display device 10 in accordance with the first embodiment makes it possible in a light-transmission mode in which the light-sources 74 are turned on to reflect a light emitted into the light-guide 7 from the light-sources 74, at the inclining surfaces 712 of the grooves 71 towards the inverted-prism sheet 6, ensuring that a light is directed towards the inverted-prism sheet 6 from the light-guide 7.

Furthermore, since a light is reflected at the inclining surfaces 712 obliquely towards the inverted-prism sheet 6, it is possible to prevent the light from reflecting at a lower surface (a surface facing the light-guide 7) of the inverted-prism sheet 6 towards the light-guide 7. Accordingly, it would be possible to enhance an efficiency at which a light is used in a light-transmission mode in comparison with the conventional liquid crystal display device, ensuring sufficient display brightness in a light-transmission mode.

It is preferable that each of the prisms 61 has an apex angle γ of 90 degrees for the purpose of reflecting a frontally coming light in a light-reflection mode, however, in which case, it would not be possible for the prisms 61 to frontally direct a light leaving the light-guide 7 in a light-transmission mode. Hence, it is more preferable that each of the prisms 61 has an apex angle γ in the range of 60 to 70 degrees both inclusive, for instance.

If the apex angle γ of each of the prisms 61 is equal to about 60 degrees, it would be possible for the prisms 61 to frontally direct a light leaving the light-guide 7 in a light-transmission mode, however, a frontally coming light would not be frontally reflected at the prisms 61 in a light-reflection mode. Thus, it is preferable to design each of the prisms 61 to have an apex angle γ of about 70 degrees.

In the first embodiment, each of the prisms 61 is formed symmetrical about a direction in which a viewer frontally views the liquid crystal display device 10. That is, assuming that each of the prisms 61 is defined with a first inclining surface 611 and a second inclining surface 612, an angle of the first inclining surface 611 relative to the above-mentioned direction is equal to an angle of the second inclining surface 612 relative to the above-mentioned direction. In FIG. 6A, the reference numerals 611 and 612 are given only to a part of the prisms 61 for simplification.

In a light-reflection mode, about 50% of frontally coming lights is reflected, and the rest of the lights are turned by about 70 degrees to direct towards the light-guide 7. In order to effectively use the lights directing towards the light-guide 7, it is necessary to regularly reflect them at the light-reflection sheet 8, and to cause them to enter the inverted-prism sheet 6 again at an angle of about 70 degrees.

For this purpose, it would be preferable to maximize an area proportion of the flat surface 72 in the light-guide 7 to prevent an angle of a path along which a light goes in an order of the inverted-prism sheet 6, the light-guide 7, the light-reflection sheet 8, the light-guide 7, and the inverted-prism sheet 6, from being changed at a lower surface of the light-guide 7.

For the same reason, it is preferable not to dispose a light-diffusive sheet or a lenticular both of which changes a light path, between the inverted-prism sheet 6 and the light-guide 7.

Furthermore, for the same reason, the upper surface 73 of the light-guide 7 is formed flat without any grooves.

The inventors conducted the experiment for measuring a light-reflection rate of the liquid crystal display device 10 in accordance with the first embodiment. Hereinbelow is explained the results of the experiment.

In the experiment, there was used TN (twisted nematic) cell as liquid crystal cell, which has a chromaticity range of 40%, a light-transmission rate of 10.7%, and a display area of 3.5 inch-size. The TN cell included light-diffused adhesive and a light-reflection polarizer plate. The inverted-prism sheet 6 and the light-reflection plate 5 were not formed integrally with each other.

The results of the experiment were as follows.

It is assumed hereinbelow that a direction in which a normal line extends from a liquid crystal panel is 0 (zero) degree. In other words, a 0-degree direction is a direction in which a viewer frontally views the liquid crystal display device. It is further assumed that a standard white plate composed of BaSO₄ has a light-reflection rate of 100%.

In the experiment, a light emitted from a ring light-source was caused to enter the liquid crystal display device at 15 degrees, and leave the liquid crystal display device at 0 degree in both a conventional liquid crystal display device and the liquid crystal display device 10 in accordance with the first embodiment.

The conventional liquid crystal display device indicated a panel light-reflection rate of 2.7%, and light-reflection contrast of 5, whereas the liquid crystal display device 10 in accordance with the first embodiment indicated a panel light-reflection rate of 4%, and light-reflection contrast of 8. The liquid crystal display device 10 in accordance with the first embodiment provided enhancement in both a panel light-reflection rate and light-reflection contrast relative to the conventional liquid crystal display device.

The results of the experiment with respect to an efficiency with which a light was used are as follows.

The conventional liquid crystal display device indicated display brightness of 2300 Cd/m² when six light-emitting diodes (LEDs) were used as a light-source. In contrast, the liquid crystal display device 10 in accordance with the first embodiment indicated display brightness in the range of 2100 to 3000 Cd/m² when two to four light-emitting diodes (LEDs) were used as a light-source.

It is obvious that the liquid crystal display device 10 in accordance with the first embodiment enhances display brightness in comparison with the conventional liquid crystal display device. This is because the light-guide 7 and the inverted-prism sheet 6 contribute to enhancement in display brightness.

Though the liquid crystal panel 11 and the backlight device 75 are separated from each other in the experiment, the light-reflection rate, the light-reflection contrast, and the display brightness would be further enhanced, if the liquid crystal panel 11 and the backlight device 75 were designed to be formed integrally with each other.

Furthermore, if the liquid crystal panel 11 and the backlight device 75 were formed integrally with each other, the liquid crystal display device 10 would have an enhanced mechanical strength, ensuring that even if the light-guide 7 and a substrate of the liquid crystal panel 11 were formed thinner, the liquid crystal display device 10 would have a sufficient mechanical strength. Accordingly, by forming the liquid crystal panel 11 and the backlight device 75 integrally with each other, the liquid crystal display device 10 could be formed thinner, and parallax in light-reflection could be avoided.

In the liquid crystal display device 10 in accordance with the first embodiment, the light-guide 7 is formed at a surface thereof facing the light-reflection sheet 8 with the grooves 71. The grooves 71 define the inclining or light-reflection surface 712 at which a light provided from the light-sources 74 is reflected obliquely towards the inverted-prism sheet 6. Hence, in a light-transmission mode in which the light-sources 74 are turned on, it is possible to reflect a light entering the light-guide 7, at the inclining surface 712 of the grooves 71 towards the inverted-prism sheet 6. Namely, an incident light entering the light-guide 7 is preferably introduced to the inverted-prism sheet 6 from the light-guide 7.

In addition, since a light is reflected at the inclining surface 712 obliquely towards the inverted-prism sheet 6, it is possible to prevent the light from reflecting towards the light-guide 7 at a lower surface of the inverted-prism sheet 6, ensuring enhancement in an efficiency with which a light is used in a light-transmission mode, in comparison with the conventional backlight device.

Furthermore, it would be possible to have a broad margin or a broad range of angles in which lights emitted from the light-sources 74 are diffused, in which lights are totally reflected at the inclining surface 712. This ensures sufficiently high display brightness in a light-transmission mode.

Furthermore, since a lower surface of the light-guide 7, that is, a surface of the light-guide 7 facing the light-reflection sheet 8 is formed as the flat surface 72 except the grooves 71, it would be possible to prevent a path of a light going through the inverted-prism sheet 6, the light-guide 7, the light-reflection sheet 8, the light-guide 7, and the inverted-prism sheet 6 in this order, from being changed at the lower surface of the light-guide 7, and further possible to reflect a light entering the light-guide 7 from the inverted-prism sheet 6, at the light-reflection sheet 8 in a light-reflection mode, ensuring enhancement an efficient with which the light is used.

That is, in a light-reflection mode, about 50% of external lights is reflected at the inverted-prism sheet 6, and the rest of external lights passes through the inverted-prism sheet 6, and reaches the light-guide 7. Since the lower surface of the light-guide 7 is formed mostly as the flat surface 72, the lights having passed through the inverted-prism sheet 6 and having reached the light-guide 7 are preferably reflected at the light-reflection sheet 8, and thus, the lights can be used effectively for displaying images therewith.

The liquid crystal display device 10 in accordance with the first embodiment may be used alone, or may be mounted on an electronic device or a mobile communication terminal such as a mobile phone or a personal digital assistant (PDA).

In the above-mentioned first embodiment, the backlight device in accordance with the present invention is applied to a liquid crystal display device. The backlight device in accordance with the present invention may be applied to any display device, if the display device is necessary to include a backlight device.

### Second Embodiment

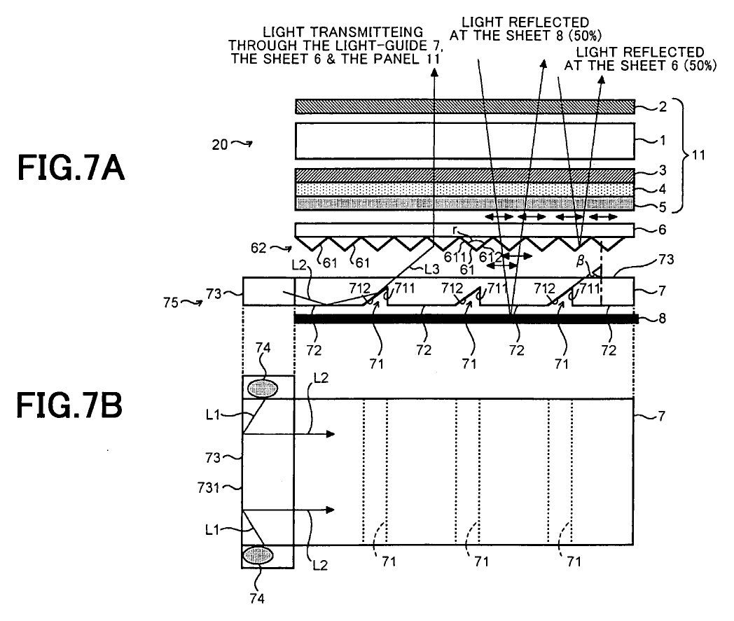

FIG. 7A is a cross-sectional view of the liquid crystal display device 20 in accordance with the second embodiment, and FIG. 7B is a top view of the light-guide 7 included in the liquid crystal display device 20.

In comparison with the liquid crystal display device 10 in accordance with the first embodiment, the liquid crystal display device 20 in accordance with the second embodiment is designed to additionally include a light-guide pipe 73 disposed adjacent to the light-guide. 7. Parts or elements that correspond to those of the liquid crystal display device 10 in accordance with the first embodiment have been provided with the same reference numerals, and operate in the same manner as corresponding parts or elements in the first embodiment, unless explicitly explained hereinbelow.

The light-guide pipe 73 is disposed adjacent to the light-guide 7 such that the light-guide pipe 73 makes contact with a left side of the light-guide 7 among the four sides of the light-guide 7, that is, a side closer to the inclining surface 712 than the surface 711 of each of the grooves 71 among the two sides extending in parallel with a direction in which the grooves 71 extend.

In the second embodiment, the light-sources 74 are disposed adjacent to the light-guide pipe 73 such that the light-sources 74 make contact with sides of the light-guide pipe 73 extending in a direction perpendicular to a direction in which the grooves 71 extend.

The backlight device 75 in the second embodiment is comprised of the inverted-prism sheet 6, the light-guide 7, the light-reflection sheet 8, the light-guide pipe 73, and the light-sources 74.

In the backlight device 75 in the second embodiment, lights L1 emitted from the light-sources 74 enter the light-guide pipe 73.

As illustrated in FIG. 7B, the lights L1 direct to a surface 731 of the light-guide pipe 73 disposed remoter from the light-guide 7, and are reflected at the surface 731 towards the light-guide 7. Then, the lights L1 enter the light-guide 7 as lights L2.

An angle at which the lights L1 are introduced into the light-guide pipe 73 from the light-sources 74, and an angle of the surface 731 of the light-guide pipe 73 at which the lights L1 are reflected towards the light-guide 7 are determined such that the lights L2 introduced into the light-guide 7 from the light-guide pipe 73 are in parallel with one another.

As mentioned earlier, if a light-source is attached directly to a light-guide as taught in Japanese Patent Application Publication No. 2004-054034, locus of lights emitted from a light-source can be seen as non-uniformity in brightness, as having been explained with reference to FIG. 5.

Since lights emitted from the light-sources 74 are reflected in the light-guide pipe 73 to turn the lights into parallel lights before the lights enter the light-guide 7, the liquid crystal display device 20 in accordance with the second embodiment can prevent non-uniformity in brightness unlike the above-mentioned conventional liquid crystal display device.

The backlight device 75 in the second embodiment is designed to additionally include the light-guide pipe 73 disposed adjacent to the light-guide 7. Lights emitted from the light-sources 74 enter the light-guide pipe 73 and are reflected in the light-guide pipe 73 towards the light-guide 7, and then, enter the light-guide 7. Furthermore, an angle at which the light L1 is introduced into the light-guide pipe 73 from the light-sources 74, and an angle of the surface 731 of the light-guide pipe 73 at which the light L1 is reflected in the light-guide pipe 73 towards the light-guide 7 are determined such that the lights L2 introduced into the light-guide 7 from the light-guide pipe 73 are in parallel with one another. Accordingly, it is possible to enhance uniformity in light in a light-transmission mode, and display high-quality images in a light-transmission mode without non-uniformity in brightness.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2004-327291 filed on Nov. 11, 2004 including specification, claims, drawings and summary is incorporated herein by reference in its entirety.

What is claimed is:

1. A backlight device used for a display device, comprising:
(a) an inverted-prism sheet;
(b) a light-guide arranged adjacent to said inverted-prism sheet;
(c) a light-reflection sheet arranged adjacent to said light-guide; and
(d) a light-source emitting a light into said light-guide,
said light-guide being formed on a first surface thereof facing said light-reflection sheet with at least one groove defining a light-reflection surface at which a light provided from said light-source is reflected obliquely towards said inverted-prism sheet.

2. The backlight device as set forth in claim 1, wherein said groove has a triangular cross-section.

3. The backlight device as set forth in claim 1, wherein said first surface is flat except said groove.

4. The backlight device as set forth in claim 1, wherein said light-reflection surface inclines at such an angle relative to a direction in which a viewer frontally views said liquid crystal display device that a light leaves said light-guide at an angle in the range of about 50 to about 80 degrees both inclusive relative to said direction.

5. The backlight device as set forth in claim 1, wherein said groove is defined by two surfaces, one of which extends perpendicularly to said first surface of said light-guide.

6. The backlight device as set forth in claim 1, wherein said inverted-prism sheet has a prism having an apex angle in the range of 60 to 70 degrees both inclusive.

7. A backlight device used for a display device, comprising:
(a) an inverted-prism sheet;
(b) a light-guide arranged adjacent to said inverted-prism sheet;
(c) a light-reflection sheet arranged adjacent to said light-guide;
(d) a light-source emitting a light into said light-guide; and
(e) a light-guide pipe arranged adjacent to said light-guide for introducing a light provided from said light-source, into said light-guide therethrough,
said light-guide being formed on a first surface thereof facing said light-reflection sheet with at least one groove defining a light-reflection surface at which a light provided from said light-source is reflected obliquely towards said inverted-prism sheet.

8. The backlight device as set forth in claim 7, wherein said light-guide pipe receives a light from said light-source, reflects said light therein, and introduces said light into said light-guide.

9. The backlight device as set forth in claim 8, wherein an angle at which a light is introduced into said light-guide pipe from said light-source, and an angle of a surface of said light-guide pipe at which a light provided from said light-source is reflected in said light-guide pipe towards said light-guide are determined such that lights introduced into said light-guide from said light-guide pipe are in parallel with one another.

10. The backlight device as set forth in claim 7, wherein said groove has a triangular cross-section.

11. The backlight device as set forth in claim 7, wherein said first surface is flat except said groove.

12. The backlight device as set forth in claim 7, wherein said light-reflection surface inclines at such an angle relative to a direction in which a viewer frontally views said display device that a light leaves said light-guide at an angle in the range of about 50 to about 80 degrees both inclusive relative to said direction.

13. The backlight device as set forth in claim 7, wherein said groove is defined by two surfaces, one of which extends perpendicularly to said first surface of said light-guide.

14. The backlight device as set forth in claim 7, wherein said inverted-prism sheet has a prism having an apex angle in the range of 60 to 70 degrees both inclusive.

15. A liquid crystal display device, comprising:
(a) a backlight device; and
(b) a liquid crystal panel arranged closer to a viewer than said backlight device,
said backlight device comprising:
(a) an inverted-prism sheet;
(b) a light-guide arranged adjacent to said inverted-prism sheet;
(c) a light-reflection sheet arranged adjacent to said light-guide; and
(d) a light-source emitting a light into said light-guide,
said light-guide being formed on a first surface thereof facing said light-reflection sheet with at least one groove defining a light-reflection surface at which a light provided from said light-source is reflected obliquely towards said inverted-prism sheet.

16. The liquid crystal display device as set forth in claim 15, wherein said groove has a triangular cross-section.

17. The liquid crystal display device as set forth in claim 15, wherein said first surface is flat except said groove.

18. The liquid crystal display device as set forth in claim 15, wherein said light-reflection surface inclines at such an angle relative to a direction in which a viewer frontally views said liquid crystal display device that a light leaves said light-guide at an angle in the range of about 50 to about 80 degrees both inclusive relative to said direction.

19. The liquid crystal display device as set forth in claim 15, wherein said groove is defined by two surfaces, one of which extends perpendicularly to said first surface of said light-guide.

20. The liquid crystal display device as set forth in claim 15, wherein said inverted-prism sheet has a prism having an apex angle in the range of 60 to 70 degrees both inclusive.

21. A liquid crystal display device, comprising:
(a) a backlight device; and
(b) a liquid crystal panel arranged closer to a viewer than said backlight device,
said backlight device comprising:
(a) an inverted-prism sheet;
(b) a light-guide arranged adjacent to said inverted-prism sheet;
(c) a light-reflection sheet arranged adjacent to said light-guide;
(d) a light-source emitting a light into said light-guide; and
(e) a light-guide pipe arranged adjacent to said light-guide for introducing a light provided from said light-source, into said light-guide therethrough,
said light-guide being formed on a first surface thereof facing said light-reflection sheet with at least one groove defining a light-reflection surface at which a light provided from said light-source is reflected obliquely towards said inverted-prism sheet.

22. The liquid crystal display device as set forth in claim 21, wherein said light-guide pipe receives a light from said light-source, reflects said light therein, and introduces said light into said light-guide.

23. The liquid crystal display device as set forth in claim 22, wherein an angle at which a light is introduced into said light-guide pipe from said light-source, and an angle of a surface of said light-guide pipe at which a light provided from said light-source is reflected in said light-guide pipe towards said light-guide are determined such that lights introduced into said light-guide from said light-guide pipe are in parallel with one another.

24. The liquid crystal display device as set forth in claim 21, wherein said groove has a triangular cross-section.

25. The liquid crystal display device as set forth in claim 21, wherein said first surface is flat except said groove.

26. The liquid crystal display device as set forth in claim 21, wherein said light-reflection surface inclines at such an angle relative to a direction in which a viewer frontally views said liquid crystal display device that a light leaves said light-guide at an angle in the range of about 50 to about 80 degrees both inclusive relative to said direction.

27. The liquid crystal display device as set forth in claim 21, wherein said groove is defined by two surfaces, one of which extends perpendicularly to said first surface of said light-guide.

28. The liquid crystal display device as set forth in claim 21, wherein said inverted-prism sheet has a prism having an apex angle in the range of 60 to 70 degrees both inclusive.
